(19) United States
(12) Patent Application Publication
(10) Pub. No.: US 2011/0279467 A1
(43) Pub. Date: Nov. 17, 2011

(54) DISPLAY APPARATUS AND METHOD FOR DECREASING MOTION BLUR THEREOF

(75) Inventors: Hyung-rae KIM, Seoul (KR); Jung-jin PARK, Seongnam-si (KR); Nak-won CHOI, Incheon (KR); Sang-un YUN, Seoul (KR)

(73) Assignee: SAMSUNG ELECTRONICS CO., LTD., Suwon-city (KR)

(21) Appl. No.: 13/106,238

(22) Filed: May 12, 2011

(30) Foreign Application Priority Data
May 12, 2010 (KR) 2010-0044403

(51) Int. Cl. G09G 3/36; G09G 5/00

(52) U.S. Cl. 345/581; 345/102

(57) ABSTRACT

A display apparatus includes a backlight part comprising a light source group; a motion analyzer for dividing a screen of the liquid crystal display panel into a plurality of regions and analyzing a motion level in each region; and a backlight controller for controlling driving of the light source group during a unit of time until image characteristics reach a maximum response point, in at least one region selected from the plurality of the regions based on the analyzed motion level. Hence, the motion blur can be decreased.

### CROSS-REFERENCE TO RELATED APPLICATIONS

This application claims priority from Korean Patent Application No. 10-2010-44403, filed on May 12, 2010, in the Korean Intellectual Property Office, the disclosure of which is incorporated herein by reference in its entirety.

### BACKGROUND

1. Field

Apparatuses and methods consistent with exemplary embodiments relate to a display apparatus and a method for decreasing motion blur thereof, and more specifically, to a display apparatus for decreasing its motion blur using an edge-type Light Emitting Device (LED) scheme, and a method for decreasing the motion blur.

2. Description of the Related Art

In general, a liquid crystal display, which is a representative display apparatus, is used to display images in a monitor of a TV or a notebook. Since the liquid crystal display cannot produce light by itself, it needs to use the light emitted from a separate light source. Hence, the liquid crystal display typically includes a backlight which serves as the light source at the rear side of a display panel. By regulating transmittance of the light emitted from the backlight according to motion of the liquid crystal display, images are represented.

Generally, when power is applied to the liquid crystal display, the backlight is driven in a hold type which maintains the ON state continuously.

The hold-type operation of the backlight results in image streaks; that is, motion blur when one frame is changed to another frame. To address this shortcoming, a scanning scheme turns on the backlight from top to bottom in sequence.

However, even with the scanning scheme, the motion blur can still be problematic in the edge-type display apparatus including the light source in the edge region of the backlight.

### SUMMARY

Exemplary embodiments overcome the above disadvantages and other disadvantages not described above. The present invention is not required to overcome the disadvantages described above, and an exemplary embodiment may not overcome any of the problems described above.

According to an aspect of one or more exemplary embodiments, a display apparatus for decreasing its motion blur by controlling a driving timing of a light source group of a backlight part, and a method for decreasing the motion blur thereof are provided.

According to an aspect of one or more exemplary embodiments, a display apparatus is provided. The display apparatus includes a backlight part including a light source group; a motion analyzer which divides a screen of a liquid crystal display panel into a plurality of regions and which analyzes a motion level of each region; and a backlight controller which controls driving of the light source group during a unit of time until image characteristics reach a maximum response point, in at least one region selected from the plurality of regions based on the analyzed motion level.

The light source group may include a plurality of Light Emitting Device (LED) light sources.

The motion analyzer may classify the plurality of the regions into a still image without motion and a video with motion, classify the plurality of the regions into an image with motion level over a threshold and an image with the motion level below the threshold, or extract a region of an image having highest motion level from the plurality of the regions.

The light source group may include first through fourth light source groups. The first light source group may be disposed in a row direction in a top edge region of the backlight part, the second light source group may be disposed in the row direction in a bottom edge region of the backlight part, the third light source group may be disposed in the row direction in the top edge region and the bottom edge region of the backlight part respectively, and the fourth light source group may be disposed in the row direction in the top edge region and the bottom edge region of the backlight part respectively and in a column direction in part of left and right edge regions.

The backlight part may include a single light source group driven together, and the backlight part may drive the single light source group during a unit of time until image characteristics in a region of a maximum motion level reach a maximum response point.

The single light source group may include first through fourth light source groups.

The backlight part may include two light source groups independently driven, and the backlight part may drive the light source group which is close to a confirmed region, from the two light source groups, during a unit time until image characteristics in the confirmed region with a maximum motion level reach a maximum response point.

The backlight part may include two light source groups independently driven. When the plurality of the regions have a maximum motion level, the backlight part may drive the light source group which is close to any one of the plurality of the regions, from the two light source groups, during a unit of time until image characteristics in one of the regions reach a maximum response point.

The two light source groups may include the third light source group and the fourth source group.

The backlight part may include three light source groups independently driven, and the backlight part may drive the light source group which is close to a confirmed region, from the three light source groups, during a unit of time until image characteristics in the confirmed region with a maximum motion level reach a maximum response point.

The backlight part may include three light source groups independently driven. When the plurality of the regions have a maximum motion level, the backlight part may drive the light source group which is close to any one of the plurality of the regions, from the three light source groups, during a unit of time until image characteristics in one of the plurality of the regions reach a maximum response point.

The three light resource groups may include the fourth source group.

The backlight controller may repeatedly drive the light source groups per unit of time until image characteristics in at least one of the regions reach a maximum response point.

The maximum response point may be calculated in advance based on a timing of the input image signal, a delay of the input image signal, a delay of a driver for driving the liquid crystal display panel, and a response speed of the liquid crystal display panel.

According to another aspect of an exemplary embodiment, a method for decreasing motion blur of a display apparatus includes dividing a screen of a liquid crystal display panel into a plurality of regions and analyzing a motion level of each region; and driving a light source group of a backlight part during a unit of time until image characteristics in at least one of the plurality of the regions reach a maximum response point, based on the analyzed motion level.

The light source group may include a plurality of Light Emitting Device (LED) light sources arranged in edge regions of the backlight part.

The light source group may include first through fourth light source groups. The first light source group may be disposed in a row direction in a top edge region of the backlight part, the second light source group may be disposed in the row direction in a bottom edge region of the backlight part, the third light source group may be disposed in the row direction in the top edge region and the bottom edge region of the backlight part respectively, and the fourth light source group may be disposed in the row direction in the top edge region and the bottom edge region of the backlight part respectively and in a column direction in part of left and right edge regions.

The driving may include driving together a single light source group in the liquid crystal display panel, during a unit of time until image characteristics in a confirmed region of the maximum motion level reach a maximum response point.

The driving may include driving independently the light source group which is close to the confirmed region, from two light source groups in the liquid crystal display panel, during a unit of time until image characteristics in the confirmed region with the maximum motion level reach a maximum response point.

When the plurality of the regions have a maximum motion level, the driving may include driving independently the light source group which is close to any one of the plurality of the regions, from two light source groups in the liquid crystal display panel, during a unit of time until image characteristics in one of the regions reach a maximum response point.

The driving may include driving independently the light source group which is close to the confirmed region, from three light source groups in the liquid crystal display panel, during a unit of time until image characteristics in the confirmed region with a maximum motion level reach a maximum response point.

When the plurality of the regions has the maximum motion level, the driving may include driving the light source group which is close to any one of the plurality of the regions, from three light source groups in the liquid crystal display panel, during a unit time until image characteristics in one of the plurality of the regions reach a maximum response point.

The driving may include repeatedly driving the light source groups per unit of time until image characteristics in at least one of the regions reach a maximum response point.

### BRIEF DESCRIPTION OF THE DRAWINGS

The above and/or other aspects of the present disclosure will become more apparent by describing certain exemplary embodiments with reference to the accompanying drawings, in which:

FIG. 1 is a block diagram illustrating a display apparatus according to an exemplary embodiment;

FIGS. 2A through 2D are views illustrating various light source arrangements of a backlight part according to an exemplary embodiment;

FIG. 3 is a timing diagram illustrating response characteristics of a liquid crystal display panel according to an exemplary embodiment;

FIGS. 4 through 10 are views illustrating various examples of controlling a drive timing of light source groups of the backlight according to one or more exemplary embodiments; and

FIG. 11 is a flowchart illustrating a method of decreasing motion blur of the display apparatus according to an exemplary embodiment.

### DETAILED DESCRIPTION OF EXEMPLARY EMBODIMENTS

Exemplary embodiments are described in greater detail below with reference to the accompanying drawings.

In the following description, analogous drawing reference numerals are used for analogous elements, even in different drawings. The matters defined in the description, such as detailed construction and elements, are provided to assist in a comprehensive understanding of the invention. However, exemplary embodiments can be practiced without those specifically defined matters. Also, well-known functions or constructions are not described in detail since they would obscure the invention with unnecessary detail.

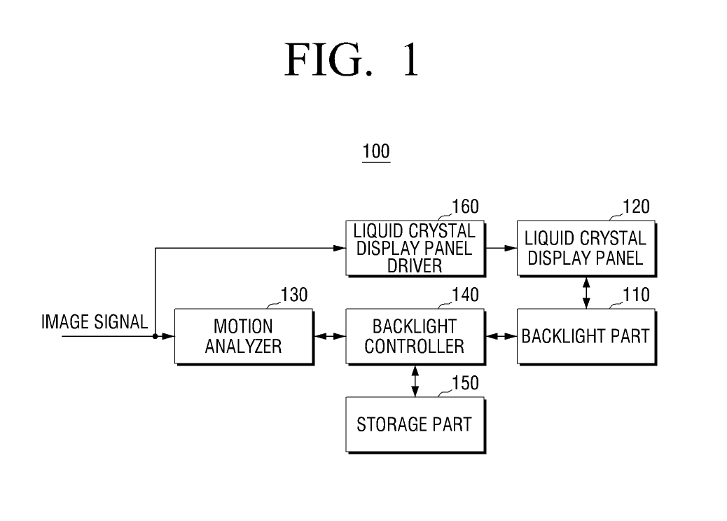

FIG. 1 is a block diagram illustrating a display apparatus according to an exemplary embodiment.

Referring to FIG. 1, the display apparatus 100 includes a backlight part 110, a liquid crystal display panel 120, a motion analyzer 130, a backlight controller 140, a storage part 150, and a liquid crystal display panel driver 160.

The backlight part 110 includes light source groups disposed in an edge region. The light source group of the backlight part 110 includes a plurality of Light Emitting Device (LED) light sources. Thus, the display apparatus 100 can be any one of various display devices such as a notebook, a desktop monitor, and a TV, where the plurality of the LEDs is disposed in the edge region of the backlight part 110.

When power is applied to the liquid crystal display panel 120 which is explained in further detail below, the backlight part 110 can be driven in a hold-type manner which continuously keeps the ON state, or in a scanning manner which turns on from top to bottom in sequence.

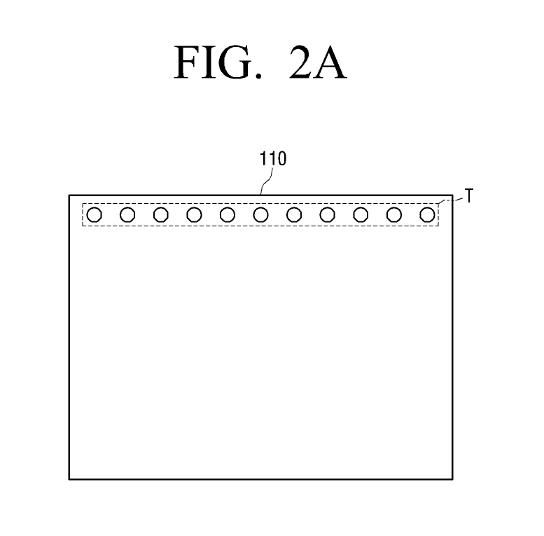

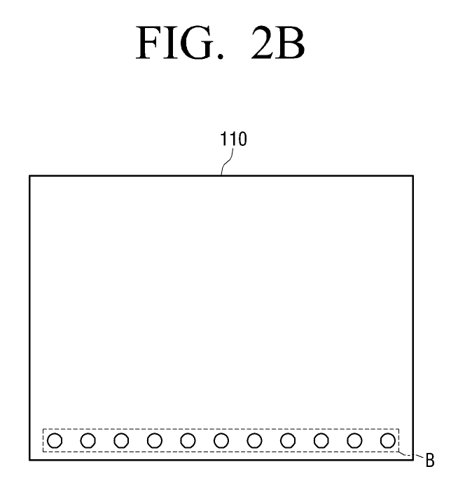

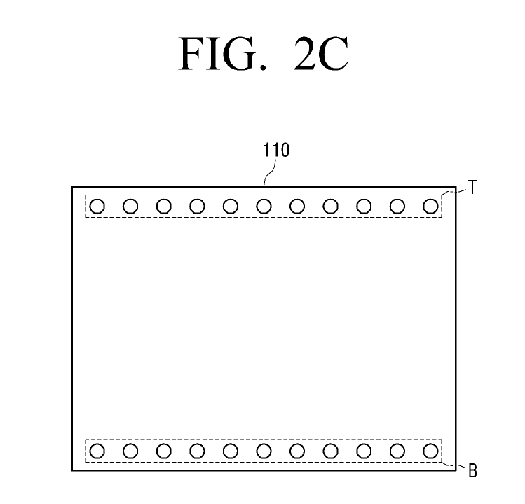

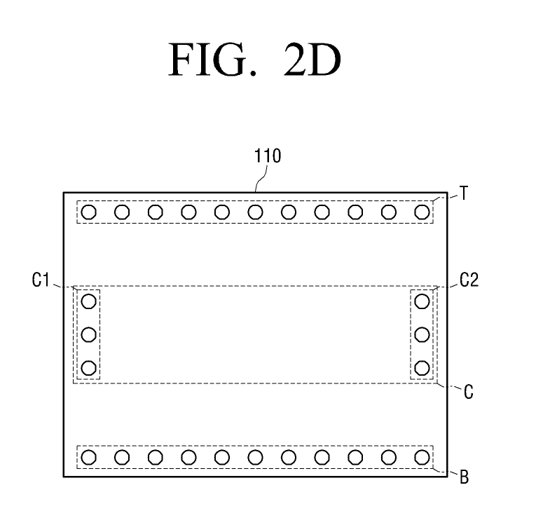

The light source groups of the backlight part 110 include a first light source group through a fourth light source group. Detailed exemplary arrangements of the light source groups of the backlight part 110 are described in further detail below with reference to FIGS. 2A through 2D.

The liquid crystal display panel 120 can display images. In more detail, since the liquid crystal display panel 120 cannot produce light by itself, the backlight part 110 serves as the light source in the rear side of the liquid crystal display panel 120. Hence, the liquid crystal display panel 120 represents the image by regulating transmittance of the light emitted from the backlight according to the motion of the liquid crystal display.

The motion analyzer 130 divides the screen of the liquid crystal display panel 120 into a plurality of regions and analyzes motion level of each region. More specifically, the motion analyzer 130 receives the screen displayed on the liquid crystal display panel 120; that is, the input image signal on the frame by frame basis (that is, one screen at a time) and provides the analysis result to the backlight controller 140.

The motion analyzer 130 analyzes the motion level using the input image per se or subtitles inserted into the input image.

The motion analyzer 130 divides a current image frame, which is the currently input image, into a plurality of subimages. By comparing the subimage with subimages corresponding to the previous frame image which is previously input, the motion analyzer 130 analyzes the motion and the motion level of each subimage.

For example, the motion analyzer 130 classifies the plurality of regions into a still image without motion and a video with the motion. More specifically, the motion analyzer 130 divides the frame image into three subimages including first, second, and third subimages, and compares a pixel value of the subimage with a pixel value of the corresponding subimage of the previous frame image. When a difference of the pixel values falls below a preset threshold, the motion analyzer 130 determines that the still image is without motion. When the difference of the pixel values exceeds the preset threshold, the motion analyzer 130 determines that the video has motion.

Alternatively, the motion analyzer 130 distinguishes the plurality of the regions in the image when the motion level exceeds a threshold, and the image when the motion level falls below the threshold in the same manner.

Alternatively, the motion analyzer 130 can extract a region having the highest motion level from the plurality of the regions in an analogous manner.

In at least one region selected based on the analyzed motion level among the plurality of the regions, the backlight controller 140 drives the light source groups during a unit of time until image characteristics reach a maximum response point.

The liquid crystal display panel driver 160 can turn on the light source groups, or turn off the light source groups.

The motion level can embrace the presence or absence of the motion, the presence or absence of the motion compared with the preset threshold, and a maximum value of the motion.

The maximum response point is when a particular pixel or the image characteristics of the divided region (i.e., gray scale, brightness, and luminance) is/are increased or decreased to an intended value.

The maximum response point is calculated in advance by considering a timing of the input image signal, a delay of the input image signal, a delay of the driver for driving the liquid crystal display panel, and a response speed of the liquid crystal display panel, and stored in the storage part 150.

Note that the maximum response point can be, for example, a certain period, rather than a specific point in time.

The storage part 150 can store various data, for example, the image divided into the plurality of regions, thresholds for determining the motion level, and a value for calculating the maximum response point.

The liquid crystal display panel driver 160 controls the driving of the input image signal and provides the input image signal to the liquid crystal display panel 120. For example, the liquid crystal display panel driver 160 can be implemented using a Timing Controller (TCON).

The display apparatus 100 can decrease the motion blur by controlling the drive timing of the light source groups of the backlight part 110 according to the motion of the input image signal.

Meanwhile, the display apparatus 100 can further include a user interface part (not shown). By means of the user interface part (not shown), a user may manually control the drive timing of the light source groups of the backlight part 110. In this case, the user interface part (not shown) can be displayed as a pop-up window and controlled by a control signal of a remote controller.

The display apparatus 100 can control the drive timing of the light source groups of the backlight part 110 not only automatically according to the image signal input to the motion analyzer 130 but also manually through the user interface part (not shown).

FIGS. 2A through 2D are views illustrating various light source arrangements of the backlight part according to an exemplary embodiment.

The light source groups of the backlight part 110 may include the first through fourth light source groups.

Referring to FIG. 2A, the first light source group T can be disposed in a row in the upper edge area of the backlight part 110, and can be one independent light source group (i.e., a single light source group) which operates together according to a driving signal. Herein, the row can generally indicate a scan line direction or a raster direction (i.e., the horizontal direction as shown).

In FIG. 2B, the second light source group B can be disposed in a row in the lower edge area of the backlight part 110, and can be one independent light source group which operates together according to the driving signal.

In FIG. 2C, the third light source group T and B can be disposed in rows in the upper edge area and the lower edge area of the backlight part 110, respectively.

The light source group T in the upper edge area and the light source group B in the lower edge area of the third light source group T and B can be one independent light source group which operates together according to the driving signal.

Alternatively, the light source group T in the upper edge area and the light source group B in the lower edge area of the third light source group T and B may operate independently according to the driving signal.

In FIG. 2D, the fourth light source group T, C, and B can be disposed in rows in the upper edge area and the lower edge area of the backlight part 110, and in columns (vertical direction) in part of left and right edge areas of the backlight part 110.

The fourth light source group T, C and B can operate as a single independent light source group according to the driving signal. Herein, the independent light source group represents light source groups which operate together according to the applied driving signal. In more detail, of the fourth light source group T, C, and B, the light source group T in the upper edge area, the light source group B in the lower edge area, and the light source group C in the left and right edge areas can work together according to the driving signal.

The fourth light source group T, C and B can operate as two independent light source groups according to the driving signal. More specifically, two independent light source groups can operate in a manner that, of the fourth light source group T, C, and B, the light source group T in the upper edge area and the light source group B in the lower edge region can work together according to the driving signal, and then the light source group C in the left and right edge areas can work. Also, two independent light source groups can operate in a manner that the light source group T in the upper edge area and the light source group C1 in the left edge area work together according to the driving signal, and then the light source group B in the lower edge area and the light source group C2 in the right edge area work together according to the driving signal.

The fourth light source group T, C and B can operate as three independent light source groups according to the driving signal. The three independent light source groups of the fourth light source group T, C and B can work in a manner that the light source group T in the upper edge area, the light source group B in the lower edge area, and the light source group C in the left and right edge areas can operate in sequence or in opposite order according to the driving signal. Also, the three independent light source groups can work in a manner that the light source group C in the left and right edge areas operates first according to the driving signal, and then the light source group T in the upper edge area and the light source group B in the lower edge area operate in sequence.

Herein, the column direction can be, in general, a data line direction (i.e., the vertical direction as shown).

The methods described in FIGS. 2A through 2D are merely exemplary, and the present disclosure is not limited to those methods.

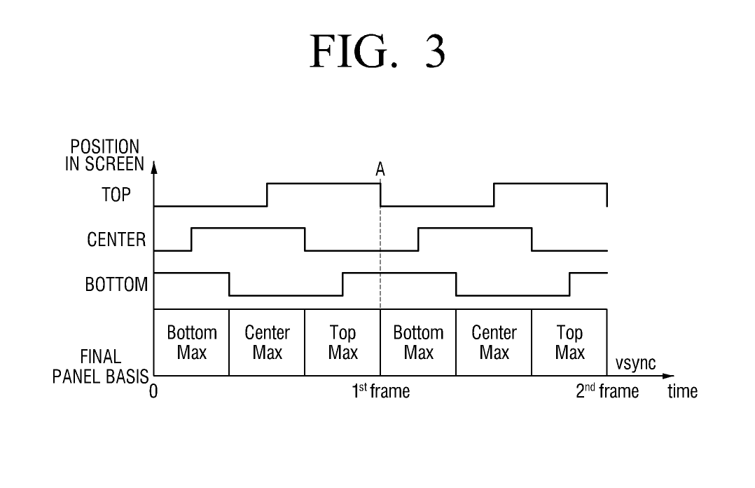

FIG. 3 is a timing chart illustrating response characteristics of the liquid crystal display panel according to an exemplary embodiment.

In FIG. 3, the plurality of the regions divided by the motion analyzer 130 includes, but not limited to, three regions: the top region, the center region, and the bottom region.

When the liquid crystal display panel 120 drives the signal in the order of the bottom region, the center region, and the top region, the maximum response point of the bottom region arrives first and the maximum response (point A) of the top region arrives last because the second frame is about to come in.

As such, the maximum response points of the divided regions are different from each other. Thus, the display apparatus 100 can independently control the drive timing of the light source group of the backlight part 110 based on the divided regions and thus further decrease the motion blur in the whole image (i.e., frame).

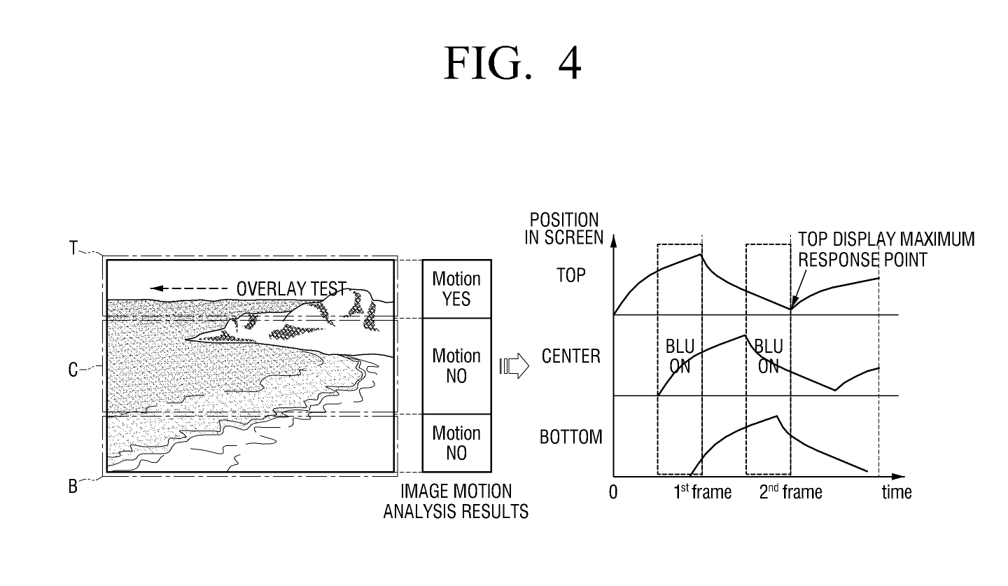

FIGS. 4 through 10 are views illustrating various examples of controlling the drive timing of the light source groups of the backlight part according to one or more exemplary embodiments.

FIGS. 4, 5 and 6 are views illustrating the light source groups of the backlight part (or backlight unit (BLU)), each of which includes one independent light source group, according to an exemplary embodiment.

FIG. 4 shows the motion occurring in the top region T of the input image.

Referring to FIG. 4, the input image is divided into three regions: the top region T, the center region C, and the bottom region B, and subtitles in the top region T are provided as an example of motion. That is, the subtitles move from the right to the left in the top region T.

When the analysis of the motion analyzer 130 confirms motion in the top region T of the input image, the backlight controller 140 can drive one independent light source group during a unit of time until the maximum response point of the top region of the liquid crystal display panel 120 is reached.

Unlike in FIG. 4, the input image can be divided into a plurality of regions, rather than three regions, and the input image can be divided vertically into a plurality of regions.

While the drive timing of the light source groups of the backlight part 110 is controlled during the first frame and the second frame in FIG. 4 to ease the understanding, the backlight controller 140 is able to control the drive timing of the light source groups of the backlight part 110 periodically. In more detail, the backlight controller 140 can repeatedly drive the light source groups per unit of time until the image characteristics in at least one of the regions arrive at the maximum response point.

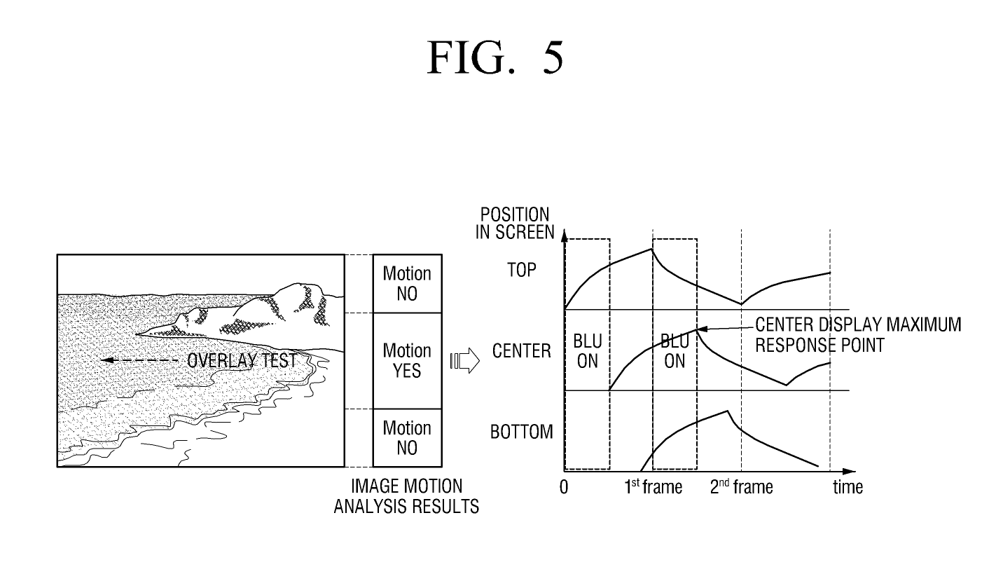

FIG. 5 is a view illustrating motion in the center region of the input image according to an exemplary embodiment.

In FIG. 5, when the subtitles move to the center region of the input image, the backlight controller 140 can drive one independent light source group during a unit of time until maximum response point of the center region of the liquid crystal display panel 120 is reached.

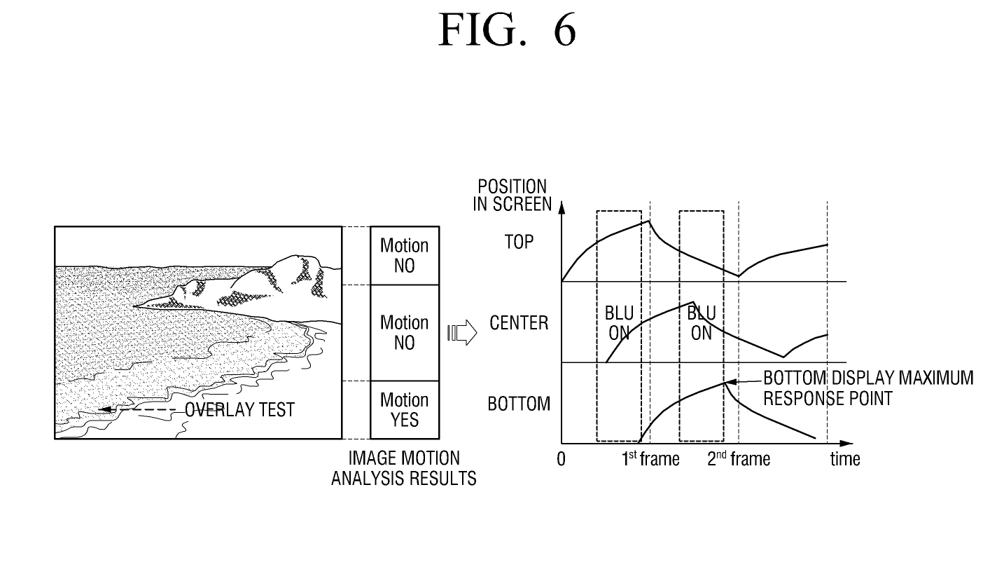

FIG. 6 is a view illustrating motion in the bottom region of the input image according to an exemplary embodiment.

In FIG. 6, when the subtitles move to the bottom region of the input image, the backlight controller 140 can drive one independent light source group for a unit of time until the maximum response point of the bottom region of the liquid crystal display panel 120 is reached.

While the motion takes place in each region in FIGS. 4, 5 and 6, respectively, any one of the three regions can have the maximum motion level according to the analysis of the motion analyzer 130 and any one of the three regions can have the motion level over a preset value.

The single independent light source group in FIGS. 4, 5 and 6 can be the single independent light source group as described in FIGS. 2A through 2D.

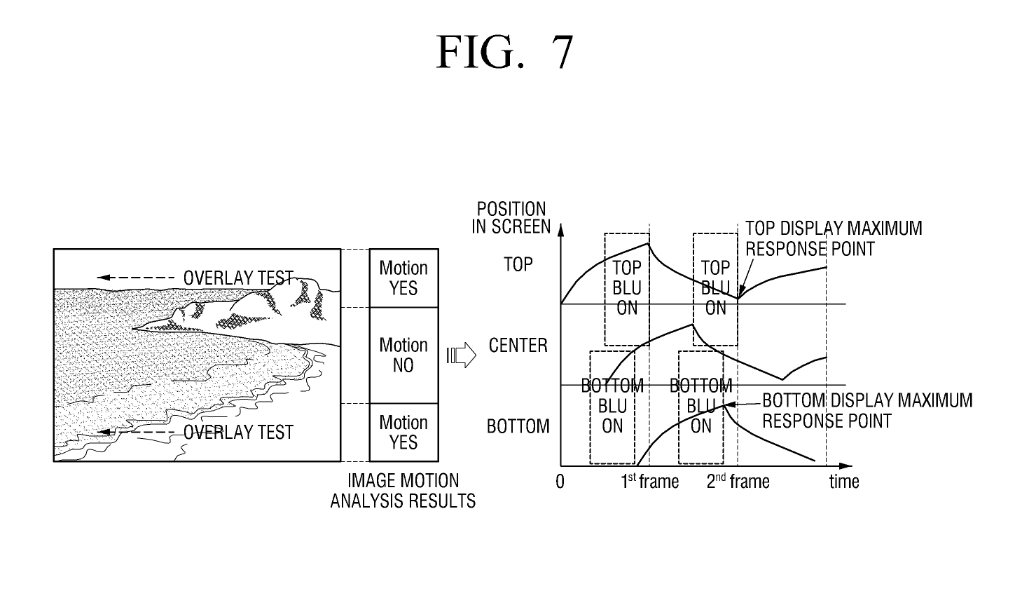

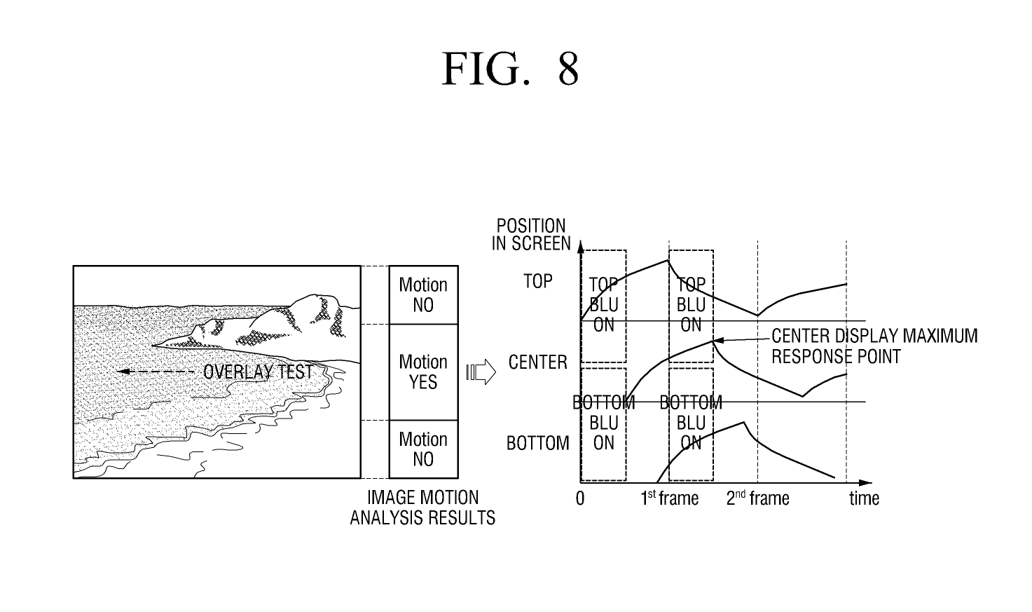

FIGS. 7 and 8 are views illustrating the light source groups of the backlight part, which include two independent light source groups, according to an exemplary embodiment.

FIG. 7 is a view illustrating motion in the top region and the bottom region of the input image according to an exemplary embodiment.

For example, it is assumed that the light sources of the backlight part 110 are arranged as shown in FIG. 2C and are operated as two independent light source groups. In this case, the backlight controller 140 can drive the light source group of the top region among the two independent light source groups during a unit of time until the maximum response point of the top region of the liquid crystal display panel 120 is reached, and drive the light source group of the bottom region from the two independent light source groups during a unit of time until the maximum response point of the bottom region of the liquid crystal display panel 120 is reached.

For example, it is assumed that the light sources of the backlight part 110 are arranged as shown in FIG. 2D, the light source group of the top region and the light source group of the center region work together as one independent light source group, and the light source group of the bottom region works as another independent light source group. At this time, the backlight controller 140 can drive the light source group of the top region and the light source group of the center region among the two independent light source groups during a unit of time until the maximum response point of the top region of the liquid crystal display panel 120 is reached, and drive the light source group of the bottom region of the two independent light source groups during a unit of time until the maximum response point of the bottom region of the liquid crystal display panel 120 is reached.

FIG. 8 is a view illustrating motion in the center region of the input image according to an exemplary embodiment.

In FIG. 8, the backlight controller 140 can drive the light source group of the top region and the light source group of the bottom region together during a unit of time until the maximum response point of the center region of the liquid crystal display panel 120 is reached.

Unlike FIG. 8, the backlight controller 140 may drive either the light source group of the top region or the light source group of the bottom region together during a unit of time until the maximum response point of the center region of the liquid crystal display panel 120 is reached.

Contrary to FIG. 8, when the input image is divided into five regions and the motion takes place in the second top region, the backlight controller 140 can operate the light source group of the top region close to the motion region from the two independent light source groups during the unit of time until the maximum response point of the second top region of the liquid crystal display panel 120 is reached.

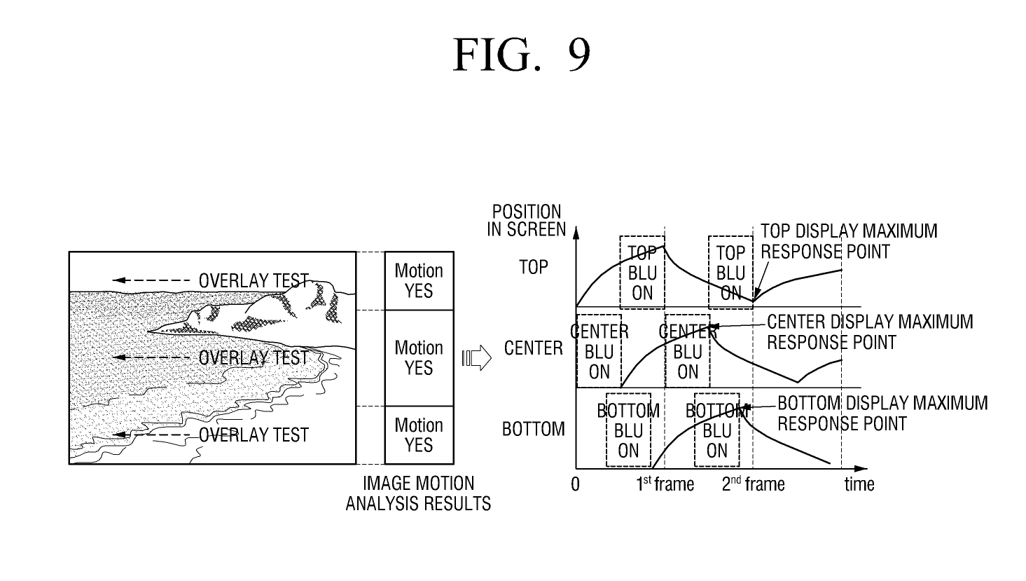

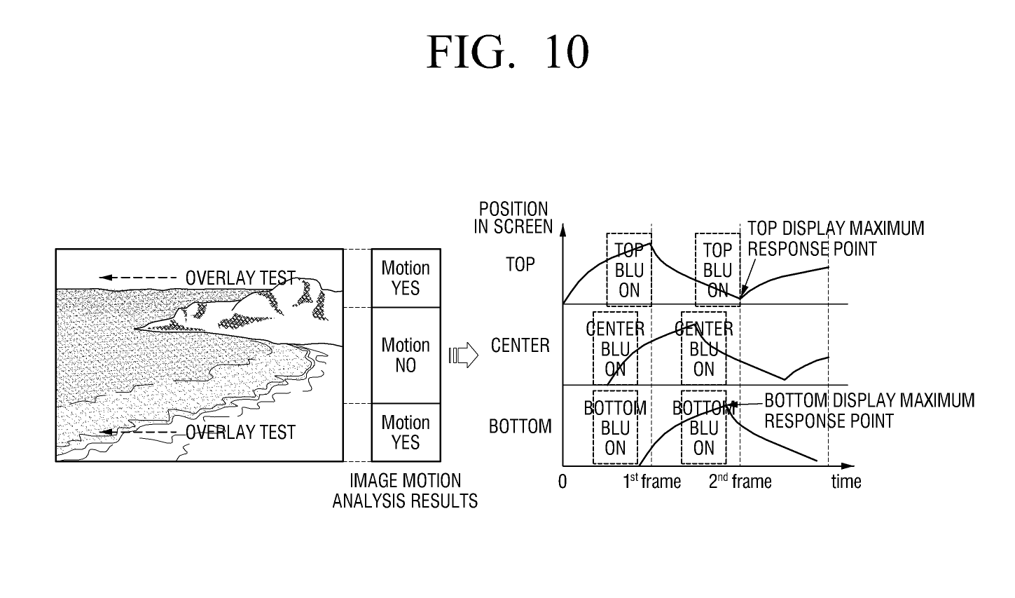

FIGS. 9 and 10 are views illustrating the light source groups of the backlight part, which include three independent light source groups according to an exemplary embodiment.

FIG. 9 is a view illustrating motion in the top region, the center region, and the bottom region of the input image according to an exemplary embodiment.

During a unit of time until the maximum response point of the top region of the liquid crystal display panel 120 is reached, the backlight controller 140 can drive the light source group of the top region from the three independent light source groups. During a unit of time until the maximum response point of the center region of the liquid crystal display panel 120 is reached, the backlight controller 140 can drive the light source group of the center region among the three independent light source groups. During a unit of time until the maximum response point of the bottom region of the liquid crystal display panel 120 is reached, the backlight controller 140 can drive the light source group of the bottom region from the three independent light source groups.

FIG. 10 is a view illustrating the motion in the top region and the bottom region of the input image according to an exemplary embodiment.

Referring to FIG. 10, during a unit of time until the maximum response point of the top region of the liquid crystal display panel 120 is reached, the backlight controller 140 can drive the light source group of the top region from the three independent light source groups. During the unit of time until the maximum response point of the bottom region of the liquid crystal display panel 120 is reached, the backlight controller 140 can drive the light source group of the bottom region from the three independent light source groups.

Yet, with respect to the light source group of the center region from the three independent light source groups, the backlight controller 140 can drive the light source group of the region close to the motion region from the light source group of the bottom region and the light source group of the top region.

In FIG. 10, under the control of the backlight controller 140, the light source group of the center region can work together with the light source group of the bottom region.

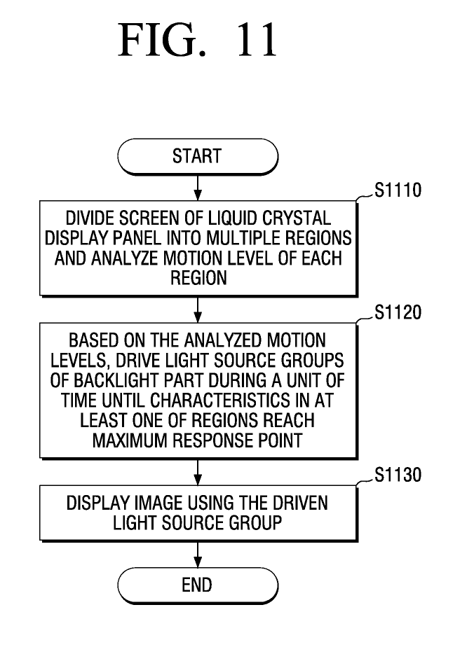

FIG. 11 is a flowchart illustrating a method of decreasing the motion blur of the display apparatus according to an exemplary embodiment.

Referring to FIG. 11, according to the method of decreasing the motion blur of the display apparatus 100, the motion analyzer 130 divides the screen of the liquid crystal display panel 120 into the plurality of the regions and analyzes the motion level of each region (S1110).

Based on the analyzed motion levels, the backlight controller 140 drives the light source groups of the backlight part 110 during a unit of time until the image characteristics in at least one region of the multiple regions reach the maximum response point (S1120).

Next, the liquid crystal display panel 120 displays the image using the driven light source group (S1130).

Thus, according to the motion characteristics of the input image, it is possible to decrease the motion blur of the display apparatus 100 by controlling the drive timing of the light source group of the backlight part 110.

Under the control of the backlight controller 140, during the driving operation (S1120) light sources in the single light source group of the liquid crystal display panel 140 are driven together during a unit of time until the image characteristics in the region of the confirmed maximum motion level reach the maximum response point.

Under the control of the backlight controller 140, during the driving operation (S1120) the light source group close to the confirmed region from the two light source groups in the liquid crystal display panel 140, is driven independently during a unit of time until the image characteristics in the region of the confirmed maximum motion level reach the maximum response point.

When the motion analyzer 130 confirms that the plurality of regions has the maximum motion level, under the control of the backlight controller 140, during the driving operation (S1120) one of the two light source groups, which is close to any one of these regions, in the liquid crystal display panel 140, is driven independently, during a unit of time until the image characteristics in one of the regions reach the maximum response point.

Under the control of the backlight controller 140, during the driving operation (S1120) the light source group close to the confirmed region from the three light source groups in the liquid crystal display panel 140, is driven independently during a unit of time until the image characteristics in the region of the confirmed maximum motion level reach the maximum response point.

When the motion analyzer 130 confirms that the plurality of the regions has the maximum motion level, under the control of the backlight controller 140, during the driving operation (S1120) one of the three light source groups, which is close to any one of these regions with maximum motion level, in the liquid crystal display panel 140, is driven independently during a unit of time until the image characteristics in one of the regions reach the maximum response point.

Under the control of the backlight controller 140, during the driving operation (S1120), the light source group can be repeatedly driven per unit of time until the image characteristics in at least one of the regions reach the maximum response point.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A display apparatus comprising:
a backlight part comprising at least one light source group;
a motion analyzer which divides a screen of a liquid crystal display panel into a plurality of regions and which analyzes a motion level of each region; and
a backlight controller which controls driving of the light source group during a unit of time until image characteristics reach a maximum response point, in at least one region selected from the plurality of regions based on the analyzed motion level.

2. The display apparatus of claim 1, wherein the light source group comprises a plurality of Light Emitting Device (LED) light sources.

3. The display apparatus of claim 1, wherein the motion analyzer classifies the plurality of the regions into a still image without motion and a video frame with motion, classifies the plurality of the regions into an image with motion level over a threshold and an image with the motion level below the threshold, or extracts a region of an image having highest motion level from the plurality of regions.

4. The display apparatus of claim 1, wherein the light source group comprises first, second, third, and fourth light source groups,
wherein the first light source group is disposed in a row direction in a top edge region of the backlight part, the second light source group is disposed in the row direction in a bottom edge region of the backlight part, the third light source group is disposed in the row direction in the top edge region and the bottom edge region of the backlight part respectively, and the fourth light source group is disposed in the row direction in the top edge region and the bottom edge region of the backlight part respectively and in a column direction in part of left and right edge regions.

5. The display apparatus of claim 4, wherein the backlight part comprises a single light source group driven together, and
the backlight part drives the single light source group during a unit of time until image characteristics in a region of a maximum motion level reach a maximum response point.

6. The display apparatus of claim 5, wherein the single light source group comprises the first, second, third, and fourth light source groups.

7. The display apparatus of claim 4, wherein the backlight part comprises two light source groups independently driven, and
the backlight part drives the light source group which is close to a confirmed region, from the two light source groups, during a unit of time until image characteristics in the region of a confirmed maximum motion level reach a maximum response point.

8. The display apparatus of claim 4, wherein the backlight part comprises two light source groups independently driven, and
when the plurality of the regions have a maximum motion level, the backlight part drives the light source group which is close to any one of the plurality of regions, from the two light source groups, during a unit of time until image characteristics in one of the plurality of regions reach a maximum response point.

9. The display apparatus of claim 7, wherein the two light source groups comprise the third light source group and the fourth source group.

10. The display apparatus of claim 4, wherein the backlight part comprises three light source groups independently driven, and
the backlight part drives the light source group which is close to a confirmed region, from the three light source groups, during a unit of time until image characteristics in a region of a confirmed maximum motion level reach a maximum response point.

11. The display apparatus of claim 4, wherein the backlight part comprises three light source groups independently driven, and
when a plurality of regions have a maximum motion level, the backlight part drives the light source group which is close to any one of the plurality of regions with the maximum motion level, from the three light source groups, during a unit of time until image characteristics in one of the plurality of regions with the maximum motion level reach a maximum response point.

12. The display apparatus of claim 10, wherein the three light source groups comprise the fourth source group.

13. The display apparatus of claim 1, wherein the backlight controller repeatedly drives the light source groups per unit of time until image characteristics in at least one of the regions reach a maximum response point.

14. The display apparatus of claim 1, wherein the maximum response point is calculated in advance based on a timing of the input image signal, a delay of the input image signal, a delay of a driver for driving the liquid crystal display panel, and a response speed of the liquid crystal display panel.

15. A method of decreasing motion blur of a display apparatus, comprising:
dividing a screen of a liquid crystal display panel into a plurality of regions and analyzing a motion level in each of the plurality of regions; and
driving a light source group of a backlight part during a unit of time until image characteristics in at least one of the plurality of regions reach a maximum response point, based on the analyzed motion level.

16. The method of claim 15, wherein the light source group comprises a plurality of Light Emitting Device (LED) light sources arranged in edge regions of the backlight part.

17. The method of claim 15, wherein the light source group comprises first, second, third, and fourth light source groups,
wherein the first light source group is disposed in a row direction in a top edge region of the backlight part, the second light source group is disposed in the row direction in a bottom edge region of the backlight part, the third light source group is disposed in the row direction in the top edge region and the bottom edge region of the backlight part respectively, and the fourth light source group is disposed in the row direction in the top edge region and the bottom edge region of the backlight part respectively and in a column direction in part of left and right edge regions.

18. The method of claim 17, wherein the driving comprises driving together light sources in a single light source group of the liquid crystal display panel, during a unit of time until image characteristics in a region of a maximum motion level reach a maximum response point.

19. The method of claim 17, wherein the driving comprises independently driving the light source group which is close to a confirmed region, from two light source groups in the liquid crystal display panel, during a unit of time until image characteristics in the confirmed region with a maximum motion level reach a maximum response point.

20. The method of claim 17, wherein, when the plurality of the regions have a maximum motion level, the driving comprises independently driving the light source group which is close to any one of the plurality of the regions, from two light source groups in the liquid crystal display panel, during a unit of time until image characteristics in one of the regions reach a maximum response point.

21. The method of claim 17, wherein the driving comprises independently driving the light source group which is close to a confirmed region, from three light source groups in the liquid crystal display panel, during a unit of time until image characteristics in the confirmed region with a maximum motion level reach a maximum response point.

22. The method of claim 17, wherein, when the plurality of the regions has a maximum motion level, the driving comprises independently driving the light source group which is close to any one of the plurality of the regions, from three light source groups in the liquid crystal display panel, during a unit of time until image characteristics in one of the plurality of the regions reach a maximum response point.

23. The method of claim 15, wherein the driving comprises repeatedly driving the light source groups per unit of time until image characteristics in at least one of the regions reach a maximum response point.

24. The display apparatus of claim 8, wherein the two light source groups comprise the third light source group and the fourth light source group.

25. The display apparatus of claim 11, wherein the three light source groups comprise the fourth light source group.

26. A method of driving a light source group, the method comprising:
dividing a screen of a liquid crystal display panel into a plurality of regions;
determining at least one region from the plurality of regions with a highest motion level; and
driving the light source group of a backlight part based on the determining.

27. The method of claim 26, wherein the driving comprises driving the light source group of a backlight part until image characteristics in the at least one region with a highest motion level reaches a maximum response point.

28. The method of claim 26, wherein the light source group is driven together and comprises a first light source subgroup positioned in a horizontal row direction in a top edge region of the backlight part and a second light source subgroup positioned in a horizontal direction in a bottom edge region of the backlight part.

29. The method of claim 28, wherein the light source group further comprises a third light source subgroup positioned in a vertical column direction in a left edge region and a right edge region of the backlight part.

30. The method of claim 29, wherein the first, second, and third light source subgroups are driven together as a single light source group.

31. The method of claim 29, wherein the first and second light source subgroups are driven independently from the third light source subgroup such that the light source subgroup closest to a region with a highest motion level is driven until characteristics in the region with the highest motion level reach a maximum response point.
